(19) United States
(12) Patent Application Publication
(10) Pub. No.: US 2018/0154578 A1
(43) Pub. Date: Jun. 7, 2018

(54) METHOD AND APPARATUS TO USE AN ADDITIVE MANUFACTURING PLATFORM

(71) Applicant: Wal-Mart Stores, Inc., Bentonville, AR (US)

(72) Inventors: Daniel B. Howell, Bentonville, AR (US); Robert C. Taylor, Rogers, AR (US); John P. Thompson, Bentonville, AR (US)

(21) Appl. No.: 15/576,545

(22) PCT Filed: May 17, 2016
(86) PCT No.: PCT/US16/32862

§ 371 Date: Nov. 22, 2017

Related U.S. Application Data
(60) Provisional application No. 62/165,571, filed on May 22, 2015.

(51) Int. Cl. B29C 64/393; G06K 15/02; B33Y 30/00; B33Y 50/02

(52) U.S. Cl. CPC B29C 64/393; B33Y 50/02; B33Y 30/00; G06K 15/1809

(57) ABSTRACT

An additive manufacturing method includes receiving an identification of a particular additive manufacturing model from a user along with a plurality of espoused manufacturing preferences. These teachings provide for automatically selecting a particular additive manufacturing platform from amongst a plurality of available additive manufacturing platforms as a function, at least in part, of the plurality of manufacturing preferences. The selected additive manufacturing platform is then used to manufacture an item based upon the particular additive manufacturing model identified by the user.

### TECHNICAL FIELD

These teachings relate generally to additive manufacturing.

### BACKGROUND

Additive manufacturing, sometimes loosely referred to as 3-D printing, comprises a known and active area of endeavor. Additive manufacturing refers generally to any of a variety of processes that manufacture three-dimensional objects by adding in a successive manner constituent raw material. So-called 3-D printers add that content through a plurality of successively-applied layers. In these regards additive manufacturing stands in stark contrast to other manufacturing techniques such as casting or molding, fabrication, stamping, and machining.

Additive manufacturing processes can accommodate a wide variety of raw materials including metals and plastics. In many cases the additive manufacturing process utilizes a corresponding additive manufacturing model. Such a model typically comprises a three-dimensional model of the desired object and is typically created using computer-aided design, a 3-D scanner, or other related techniques. Additive manufacturing models are typically expressed via corresponding modeling software.

Additive manufacturing is generally viewed as holding great promise, especially for many semi-custom or otherwise specialized purposes. For example, additive manufacturing offers a potentially effective and efficient way to build rare items (such as spare parts for obsolete apparatuses) and otherwise relatively unique items. That said, there are already a great variety of additive manufacturing platforms that differ greatly from one another with respect to their utilized material, size, “print” resolution, speed, need for a corresponding attendant's supervision, and so forth. It is therefore unlikely, at leak for the foreseeable future, that a single additive manufacturing platform will be capable of meeting or exceeding all requirements of all possible users for all possible applications.

### BRIEF DESCRIPTION OF THE DRAWINGS

The above needs are at least partially met through provision of the method and apparatus to use an additive manufacturing platform described in the following detailed description, particularly when studied in conjunction with the drawings, wherein:

FIG. 1 comprises a flow diagram as configured in accordance with various embodiments of these teachings; and

FIG. 2 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an additive manufacturing method includes receiving an identification of a particular additive manufacturing model from a user along with a plurality of espoused manufacturing preferences. The process provides for automatically selecting a particular additive manufacturing platform from amongst a plurality of available additive manufacturing platforms as a function, at least in part, of the plurality of manufacturing preferences. The selected additive manufacturing platform is then used to manufacture an item based upon the particular additive manufacturing model identified by the user.

These teachings are highly flexible in practice and will accommodate a wide variety of modifications and variations. The aforementioned manufacturing preferences can include one or more of a desired manufacturing material, a specification regarding print resolution, a desired location to receive the manufactured item (including, for example, an in-store pickup option), a performance timeline, and one or more size dimensions for the item, to note but a few examples in these regards.

These teachings will also accommodate taking into account any of a variety of finishing steps that correspond to manufacturing the item. Examples in these regards include, but are not limited to, cleaning, removal of scaffolding or other supporting material, polishing, curing, sealing, painting, packaging, and post-manufacturing storage.

When making the aforementioned automatic selection of a particular additive manufacturing platform, these teachings can take into account, if desired, information regarding availability of one or more manufacturing materials as well as retail operational considerations at the available additive manufacturing platforms. The latter consideration can include, for example, information regarding staff availability at the otherwise-available additive manufacturing platforms.

If desired, these teachings can further accommodate user customization of the identified additive manufacturing model. This customization can include, for example, information to add to the model such that the information appears on the item when manufactured. Examples of such information include text, non-text symbols, images, and even another additive manufacturing model.

So configured, these teachings provide an inexpensive yet effective mechanism for selecting and utilizing a particular additive manufacturing platform that best suits the various needs and preferences as pertain to a particular user, model, and user requirements. Although these teachings can lead to platform selections that may, at least at first blush, appeared to be counterintuitive, these automated selections can nevertheless yield final results that a user will find positive and satisfactory. These teachings can be readily employed with essentially any additive manufacturing technique and/or additive manufacturing model. These teachings will also readily accommodate essentially any user preference including preferences that do not necessarily relate directly and specifically to the technological specifications of such platforms.

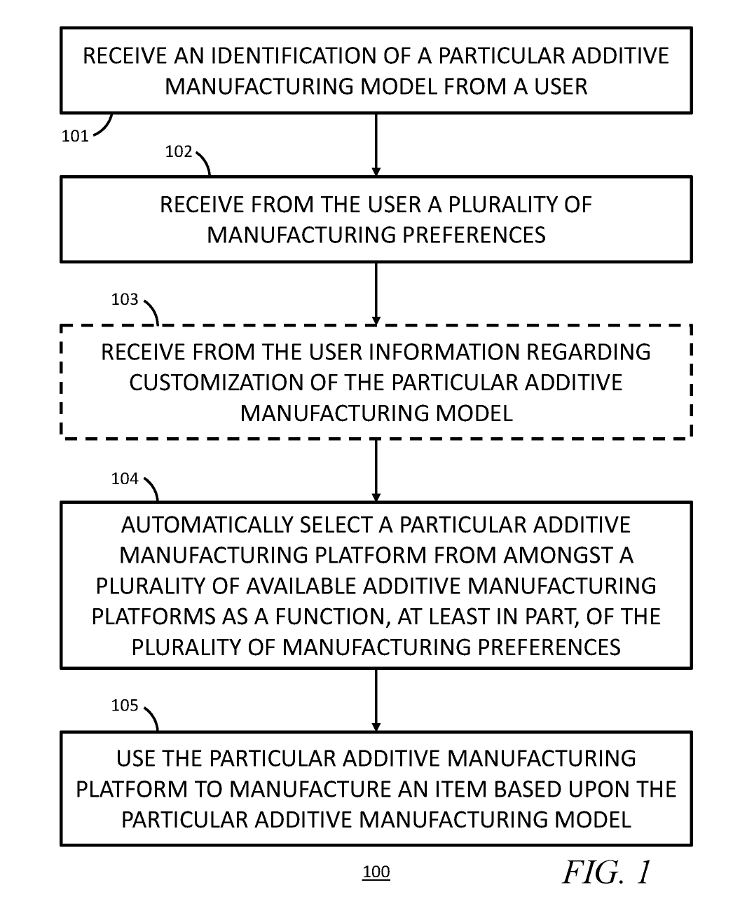

These and other benefits may become clearer upon making a thorough review and study of the following detailed description. Referring now to the drawings, and in particular to FIG. 1, an illustrative process 100 that is compatible with many of these teachings will now be presented.

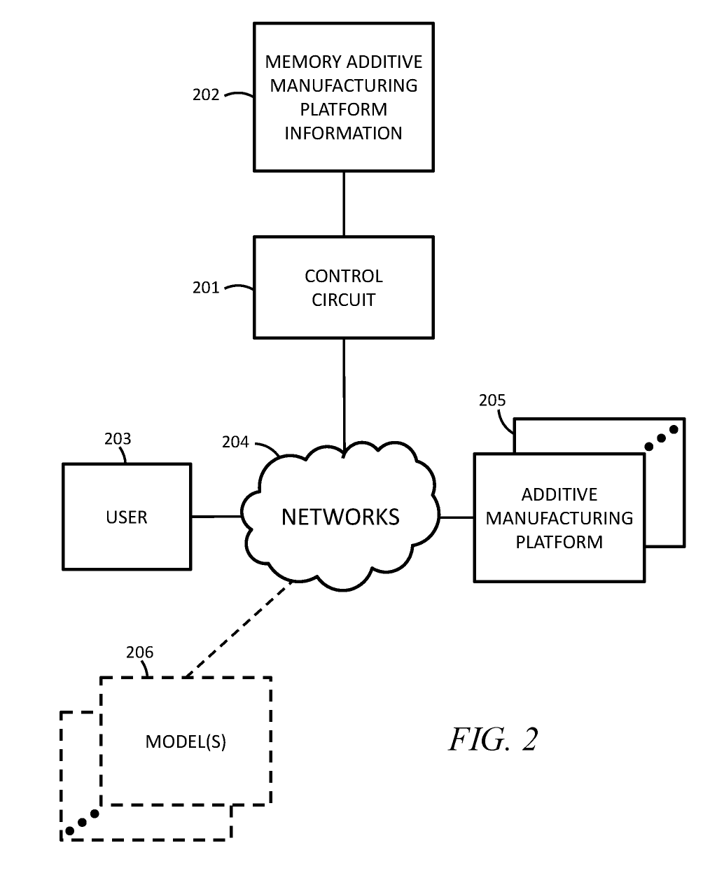

This process 100 can be carried out, for example, by a control circuit of choice. FIG. 2 provides an illustrative example in these regards. In this example the enabling apparatus includes a control circuit 201 that operably couples to a memory 202. Such a control circuit 201 can comprise a fixed-purpose hard-wired platform or can comprise a partially or wholly programmable platform. These architectural options are well known and understood in the art and require no further description here. This control circuit 201 is configured (for example, by using corresponding programming as will be well understood by those skilled in the art) to carry out one or more of the steps, actions, and/or functions described herein.

The memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 communicatively couples to a user 203 via one or more intervening networks 204. These networks 204 may be wireless or non-wireless, in whole or in part, as is well understood in the art. The user 203 communicates with the control circuit 201 via a suitable network interface such as a computer (including laptop and pad/tablet-styled computers so-called smart phones, and so forth.

In this illustrative example the control circuit 201 also communicates with a plurality of additive manufacturing platforms 205. For the sake of simplicity it will be presumed in this description that each of these additive manufacturing platforms 205 comprises a 3-D printer. It will be understood, however, that no specific limitations in those regards are intended by way of this point of specificity.

With continued reference to both FIG. 1 and FIG. 2, at block 101 this process 100 provides for the control circuit 201 receiving an identification of a particular additive manufacturing model from a user 203. By one approach, the user 203 transfers from the user 203 to the control circuit 201 via the network 204 the particular additive manufacturing model. By another approach, the user 203 identifies in some appropriate way the model without also transferring the model directly to the control circuit 201. In the latter case, the user 203 may be identifying a particular additive manufacturing model from amongst a plurality of available additive manufacturing models 206 that may be accessible via the aforementioned network 204 or another network of choice.

At block 102 the control circuit 201 also receives from the user 203 a plurality of manufacturing preferences. By one approach this plurality of manufacturing preferences includes a preference regarding at least one desired manufacturing material (such as between metal or plastic, or a particular kind of metal or plastic) and at least one specification regarding print resolution (which specification may constitute a particular print resolution or a range of acceptable print resolutions).

By another approach, in lieu of the foregoing or in combination therewith, the plurality of manufacturing preferences may include a desired location to receive the item. The location might be identified, for example, by a street address, postal code, municipality, or the like. As another example in these regards, the location may be elicited from the user 203 by providing the user 203 with an opportunity to select an in-store pickup option. For example, the user 203 may be provided with the option to pick up the manufactured item at a particular store at a particular address.

By yet another approach, and again in lieu of the foregoing or in combination therewith, the plurality of manufacturing preferences may include a performance timeline and/or at least one size dimension for the item. The performance timeline, when specified, may specify an item-completion deadline and/or an item-availability deadline. The size dimension may correspond to an overall scaling of the item such as 100%, 50%, 200%, and so forth) or may specify a particular dimension for the item (such as length but not width).

By one approach the control circuit 201 can also receive from the user prioritization information regarding one or more of the manufacturing preferences. This prioritization information can be direct or indirect. By one approach, the user can prioritize the manufacturing preferences by identifying one or more circumstances as correspond to the manufacturing preferences as being of greater importance. For example, a user may want the best quality product at the best price, so they would prioritize quality and price. This means the system could respond by choosing the best printer to create the product, regardless of how long it will take to the product to be created and regardless of how long it will take to ship the product. Accordingly, and by way of a more specific illustrative example, the system could choose a centralized print distribution center (with several more-expensive, larger, high-quality printers) as verseus sending the print job to a more local facility such as a local store having less expensive, fair-quality printers.) Conversely, if time to completion is the user's priority, the system might direct a print job to a near-by facility with printers that are less busy, are relatively faster than other printers in the system, and/or that use materials that are readily available.

By one optional approach, illustrated at optional block 103, the control circuit 201 can also receive from the user 203 information regarding customization of the particular additive manufacturing model. By one approach this user information comprises, at least in part, information to add to the particular additive manufacturing model such that the information appears on the item when manufactured. As one example in these regards the user information regarding customization of the identified additive manufacturing model may comprise, at least in part, information regarding a change in geometry.

Such information may also comprise, for example, text. An example in these regards might be the name of the user or the name of an intended recipient of the item. Such information may also comprise one or more symbols (it being understood that as used herein the word “symbol” excludes alphabetic, numeric, and other related alphanumeric symbols). Examples here can include such things as logos or the like. Such information might also comprise an image such as an artist's rendering or a photographic image. And, as yet another example, such information might comprise another additive manufacturing model. An example here might comprise a pedestal to be added to the bottom of a figurine, the figurine being specified by the additive manufacturing model initially selected by the user and the pedestal being specified as a point of customization.

As another example, such customization information might comprise identifying one or more accoutrements to be added to the item to be manufactured via an additive manufacturing process. Simple examples in these regards include a fastener, a magnet, a pin, a reflective surface such as a mirror, a gemstone, a small clothing item or hat or sword for a figurine, and so forth) that someone might wish to have added to their item. Such accoutrements might be drawn from an available library-based selection of accoutrements (either as offered via the control circuit 201 or via, some third-party source) or might be an item that the user 203 provides directly for these purposes (via, for example, a delivery service).

Accordingly, and by way of an illustrative example that is offered without intending any specific limitations, in a given application setting the user 203 may identify a plurality of manufacturing preferences that include, say, at least three of one or more desired manufacturing materials, at leak one specification regarding print resolution, a specification of desired color or combination of colors, a desired location to receive the item, a performance timeline, at least one size, weight, or volume dimension for the item, an estimated target price point for the item, a brand, trademark, or other retail categorizations of items (such as a universal product code), and a selection from a library of manufacturing accoutrements.

In any event, at block 104 the control circuit 201 automatically selects a particular additive manufacturing platform from amongst a plurality of available additive manufacturing platforms 205 as a function, at least in part, of the plurality of manufacturing preferences. The control circuit 201 can also take into account prioritization preferences and/or customization information when proffered by the user 203 as described above.

In some cases the selection may comprise a relatively straightforward process. For example, when the user 203 dictates use of a relatively unique material, and only one of the additive manufacturing platforms 205 is capable of using that material, selection of that particular additive manufacturing platform is straightforward.

In other cases, however, a number of the candidate additive manufacturing platforms 205 may be suitable to a greater or lesser extent such that the selection of a particular one of these platforms is not so straightforward. For example, the user's expressed manufacturing preferences regarding material, resolution, and time of delivery may narrow the field to two candidate platforms but without a clear winner being evident. For example, one platform may be able to exactly meet the resolution requirement but may offer a delivery time that is later than the user 203 has specified while the other candidate platform may be able to meet the delivery time but offers a resolution result that is slightly less than the resolution expressed by the user 203.

In such a case, prioritization information provided by the user and/or intuited by the control circuit 201 based upon the user's input can help to identify a best platform for this particular order. For example, if the user's need to have the manufactured item by or before the delivery date is paramount, then the best choice may be to select the lower-resolution platform in order to ensure satisfaction with respect to the more-important delivery date.

By one approach the control circuit 201 may also base selection of a particular additive manufacturing platform upon information regarding finishing steps that necessarily or likely correspond to manufacturing the item. Finishing steps may likely not be included amongst the user's selected manufacturing preferences but are, nevertheless, often an important aspect of manufacturing a satisfactory item. Examples of finishing steps that are often relevant to an additive manufacturing process include cleaning, removal of scaffolding or other supporting material, polishing, curing, sealing, painting, packaging, and post-manufacturing storage (to protect, for example, environmentally sensitive items). Taking finishing requirements into account can also help the control circuit 201 to select from amongst the plurality of additive manufacturing platforms 205, in some cases again leading to selection of a platform that may otherwise appear nonintuitive or even suboptimal when judged only on the basis of espoused manufacturing preferences.

As yet another approach in these regards, used alone or in combination with one or more of the foregoing considerations, the control circuit 201 can effect its automatic selection as a function, at least in part, of information regarding present (or near-term) availability of manufacturing materials at the available additive manufacturing platforms 205. As a simple example in these regards, the control circuit 201 may ultimately select a particular platform that, although incapable of completely meeting print resolution requirements, has the requisite material immediately on hand and can therefore meet the user's delivery date as compared to another platform that is capable of meeting the user's print resolution requirements but which lacks an available supply of the requisite material.

And as yet another approach in these regards, the control circuit 201 can take into account information regarding retail operational considerations at the available additive manufacturing platforms such as staff availability at the available additive manufacturing platforms and/or operating hours. For example, a particular additive manufacturing model may be classified as being particularly difficult and hence requiring an available attendant who has at least a requisite degree of particular training and experience. In that case, the control circuit 201 may favor selection of a platform at a location having such an attendant as versus another platform that, while perhaps preferable in terms of its technical specifications, lacks present availability of such an attendant.

By one approach the control circuit's selection of a particular additive manufacturing platform is transparent to the user, such that the particular selection being made is unknown to the user 203. By another approach the control circuit 201 may present that selection to the user 203, either as a point of information or to provide the user with an opportunity to not accept that selection and/or to cancel the order. By yet another approach the control circuit 201 may present two or more candidate selections to the user 203 along with highlighting or the like to indicate the control circuit's preferred selection while nevertheless giving the user 203 the opportunity to make their own selection if they so wish.

At block 105 the control circuit 201 then uses the particular additive manufacturing platform to manufacture the item based upon the additive manufacturing model identified by the user. By one approach the control circuit 201 transfers all or part of that additive manufacturing model to the selected additive manufacturing platform. By another approach the control circuit 201 provides some identifier to the selected additive manufacturing platform such that the latter can retrieve the model itself. To the extent that the user has provided customization information, the control circuit 201 can also transfer that customization information to the additive manufacturing platform along with any other performance requirements such as delivery-date requirements, delivery-location requirements, packaging requirements, and so forth.

So configured, these teachings greatly facilitate helping a user to employ an additive manufacturing process to manufacture a desired item without overburdening the user with numerous and arcane considerations. These teachings can be readily implemented, in part, using well known communication interfaces such as the Internet.

Those skilled in the art will recognize that a wide variety of modifications, alterations, and combinations can be made with respect to the above described embodiments without departing from the scope of the invention. As but one example in these regards, by one approach the control circuit 201 can present the specifications corresponding to the users job to the plurality of additive manufacturing platforms 205 to elicit responses regarding an ability to meet those requirements or even to facilitate a competitive bidding process to provide the user with corresponding benefits. It will therefore be understood that such modifications, alterations, and combinations are to be viewed as being within the ambit of the inventive concept.

What is claimed is:

1. An additive manufacturing method comprising:
receiving an identification of a particular additive manufacturing model from a user;
receiving from the user a plurality of manufacturing preferences;
automatically selecting a particular additive manufacturing platform from amongst a plurality of available additive manufacturing platforms as a function, at least in part, of the plurality of manufacturing preferences; and
using the particular additive manufacturing platform to manufacture an item based upon the particular additive manufacturing model.

2. The additive manufacturing method of claim 1 wherein receiving the identification of the particular additive manufacturing model comprises receiving an identification of a particular additive manufacturing model from amongst a plurality of available additive manufacturing models.

3. The additive manufacturing method of claim 1 wherein the plurality of manufacturing preferences include:
at least one desired manufacturing material; and
at least one specification regarding print resolution.

4. The additive manufacturing method of claim 3 wherein the plurality of manufacturing preferences further include:
a desired location to receive the item.

5. The additive manufacturing method of claim 4 wherein receiving from the user a plurality of manufacturing preferences that include a desired location to receive the item includes providing the user with an opportunity to select an in-store pickup option.

6. The additive manufacturing method of claim 4 wherein the plurality of manufacturing preferences further include at least one of:
a performance timeline; and
at least one size dimension for the item.

7. The additive manufacturing method of claim 4 wherein receiving from the user the plurality of manufacturing preferences further includes having the user prioritize the manufacturing preferences by identifying a circumstance as corresponds to one of the manufacturing preferences as being of greater importance.

8. The additive manufacturing method of claim 1 wherein automatically selecting the particular additive manufacturing platform from amongst the plurality of available additive manufacturing platforms is further conducted as a function, at least in part, of finishing steps corresponding to manufacturing the item.

9. The additive manufacturing method of claim 8 wherein the finishing steps include at least some of:
cleaning;
removal of scaffolding or other supporting material;
polishing;
curing;
sealing;
painting
packaging; and
post-manufacturing storage.

10. The additive manufacturing method of claim 1 wherein automatically selecting the particular additive manufacturing platform from amongst the plurality of available additive manufacturing platforms is further conducted as a function, at least in part, of information regarding availability of at least one of manufacturing materials and retail operational considerations at the available additive manufacturing platforms.

11. The additive manufacturing method of claim 1 wherein automatically selecting the particular additive manufacturing platform from amongst the plurality of available additive manufacturing platforms is further conducted as a function, at least in part, of information regarding staff availability at the available additive manufacturing platforms.

12. The additive manufacturing method of claim 1 further comprising:
receiving from the user information regarding customization of the particular additive manufacturing model.

13. The additive manufacturing method of claim 12 wherein the user information regarding customization of the particular additive manufacturing model comprises, at least in part, information to add to the particular additive manufacturing model such that the information appears on the item when manufactured, where that information is comprised of at least some of:
text;
a symbol;
an image;
an additive manufacturing model.

14. The additive manufacturing method of claim 12 wherein the user information regarding customization of the particular additive manufacturing model comprises, at least in part, information regarding a change in geometry.

15. An apparatus to facilitate additive manufacturing, the apparatus comprising:
a memory having information stored there in regarding a plurality of available additive manufacturing platforms;
a control circuit operably coupled to the memory and configured to:
receive an identification of a particular additive manufacturing model from a user;
receive from the user a plurality of manufacturing preferences;
automatically select a particular additive manufacturing platform from amongst the plurality of available additive manufacturing platforms as a function, at least in part, of the plurality of manufacturing preferences;
use the particular additive manufacturing platform to manufacture an item based upon the particular additive manufacturing model.

16. The apparatus of claim 15 wherein the plurality of manufacturing preferences include at least three of:
at least one desired manufacturing material;
at least one specification regarding print resolution;
a specification of desired color or combination of colors;
a desired location to receive the item;
a performance timeline;
at least one size, weight, or volume dimension for the item,
an estimated target price point for the item;
a brand, trademark, or other retail categorizations of items; and
a selection from a library of manufacturing accoutrements.

17. The apparatus of claim 16 wherein the control circuit is further configured to have the user prioritize the manufacturing preferences by identifying a circumstance as corresponds to one of the manufacturing preferences as being of greater importance.

18. The apparatus of claim 16 wherein the control circuit is configured to automatically select the particular additive manufacturing platform from amongst the plurality of available additive manufacturing platforms as a further function, at least in part, of finishing steps corresponding to manufacturing the item.

19. The apparatus of claim 16 wherein the control circuit is further configured to receive from the user information regarding customization of the particular additive manufacturing model.

20. The apparatus of claim 19 wherein the user information regarding customization of the particular additive manufacturing model comprises, at least in part, at least one of:
information regarding at least one of text, symbol, and an image to add to the particular additive manufacturing model such that the information appears on the item when manufactured; and
information regarding a change in geometry.
